(19) United States
(12) Patent Application Publication
(10) Pub. No.: US 2026/0077282 A1
(43) Pub. Date: Mar. 19, 2026

(54) SEPARATION DEVICE, SHEET PRODUCTION APPARATUS, AND METHOD OF PRODUCING FILTRATION PRODUCT

(71) Applicant: SEIKO EPSON CORPORATION, Tokyo (JP)

(72) Inventors: Naoto ARUGA, Matsumoto (JP); Toshizo NISHI, Azumino (JP); Shinichi FURIHATA, Azumino (JP)

(21) Appl. No.: 19/329,616

(22) Filed: Sep. 16, 2025

(30) Foreign Application Priority Data
Sep. 18, 2024 (JP) 2024-160855

(51) Int. Cl. B01D 33/15; D21F 13/06

(52) U.S. Cl. CPC B01D 33/155; D21F 13/06

(57) ABSTRACT

A separation device includes a rotating sieve including a mesh, a wall portion that defines a space in which the sieve rotates, a cover member that covers a gap between an annular portion on an outer periphery of the sieve and the wall portion, and an upper frame outside the space in which the sieve rotates, the cover member has an outer portion along the upper frame, an inner portion along the annular portion, and a bent portion between the outer portion and the inner portion, and the bent portion causes the inner portion to follow a change in a relative position between the sieve and the upper frame.

The present application is based on, and claims priority from JP Application Serial Number 2024-160855, filed September 18, 2024, the disclosure of which is hereby incorporated by reference herein in its entirety.

### BACKGROUND

### 1. Technical Field

The present disclosure relates to a separation device, a sheet production apparatus including the separation device, and a method for producing a filtration product.

### 2. Related Art

For example, JP-A-2019-84504 discloses a separation device in which a defibrated material containing fibers is blown onto a mesh disk, which is a disk-shaped sieve provided with a mesh, and a remaining filtration product that has not passed through openings of the mesh is suctioned. The separation device includes a mesh disk, a defibrated material blowing pipe disposed on a front surface side of the mesh disk for blowing a defibrated material containing fibers, a suction pipe disposed on a back surface side of the mesh disk for sucking waste powder that has passed through openings, and a collection pipe disposed on the front surface side of the mesh disk for sucking a remaining filtration product that has not passed through the openings of the mesh disk as a raw material for processing.

According to the above document, the mesh disk is rotatably supported by a support portion that supports an outer periphery of the mesh disk.

However, there is room for improvement in the separation device of JP-A-2019-84504. Specifically, there is a problem in which the filtration product accumulating on the front surface of the mesh disk moves to an outer peripheral edge of the mesh disk due to a centrifugal force or an airflow, and a gap between the mesh disk and the support portion is clogged with the filtration product, thereby causing a rotation failure of the mesh disk.

### SUMMARY

A separation device according to an aspect of the present application includes a rotating sieve including a mesh, a wall portion that defines a space in which the sieve rotates, a cover member that covers a gap between an annular portion on an outer periphery of the sieve and the wall portion, and an upper frame outside the space in which the sieve rotates, the cover member has an outer portion along the upper frame, an inner portion along the annular portion, and a bent portion between the outer portion and the inner portion, and the bent portion causes the inner portion to follow a change in a relative position between the sieve and the upper frame.

A sheet production apparatus according to an aspect of the present application includes the separation device described above, a defibrating unit that defibrates a raw material, an accumulating unit that accumulates a material to from a web, and a forming unit compresses the web to from a sheet, and the separation device selects a filtration product from air containing the filtration product and foreign matter defibrated by the defibrating unit and supplies the selected filtration product to the accumulating unit as the material.

A method for producing a filtration product according to an aspect of the present application is a method for producing a filtration product using a separation device including a rotating sieve including a mesh, a wall portion that defines a space in which the sieve rotates, a cover member that covers a gap between an annular portion on an outer periphery of the sieve and the wall portion, and an upper frame outside the space in which the sieve rotates, in which the cover member has an outer portion along the upper frame, an inner portion along the annular portion, and a bent portion between the outer portion and the inner portion, the method including supplying a raw material in which a filtration product and foreign matter are mixed to a front surface side of the sieve, using the bent portion to cause the inner portion to follow a change in a relative position between the sieve and the upper frame caused by rotation, after the rotation, collecting the foreign matter from one of the front surface side and a back surface side of the sieve, and after the rotation, collecting the filtration product from another one of the front surface side and the back surface side of the sieve.

### BRIEF DESCRIPTION OF THE DRAWINGS

FIG. 1 is a perspective view of a separation device according to a first embodiment.

FIG. 2 is an exploded perspective view of a main portion of the separation device.

FIG. 3 is an explanatory view of a function of the separation device.

FIG. 4 is a plan view of a back surface of a cover member.

FIG. 5 is an exploded perspective view of the cover member.

FIG. 6 is a side sectional view of the cover member at a time of assembly.

FIG. 7 is a partial plan view of a sheet.

FIG. 8 is an enlarged view of a portion VIII in FIG. 2.

FIG. 9 is a partial plan view of the cover member.

FIG. 10 is an explanatory view of an overlapped state.

FIG. 11 is a sectional view taken along line XI-XI of FIG. 9.

FIG. 12 is a flowchart illustrating a flow of a method for producing a filtration product by the separation device.

FIG. 13 is a schematic configuration diagram of a sheet production apparatus according to a second embodiment.

### DESCRIPTION OF EMBODIMENTS

### First Embodiment

### Overview of Separation Device

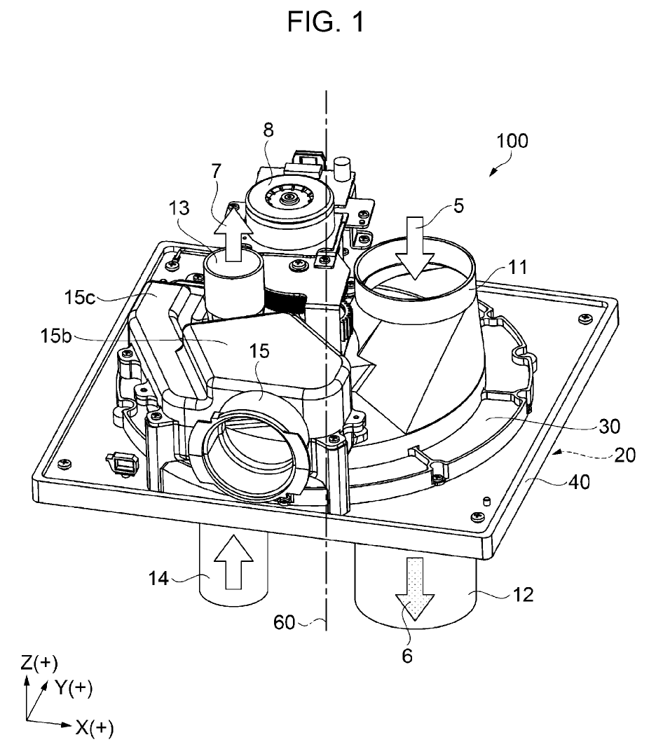

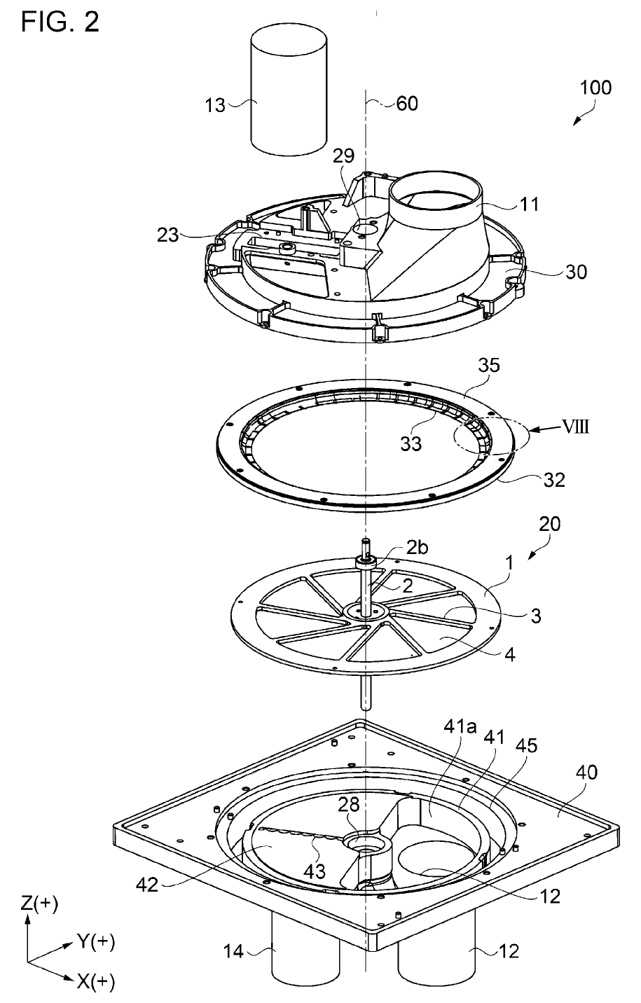

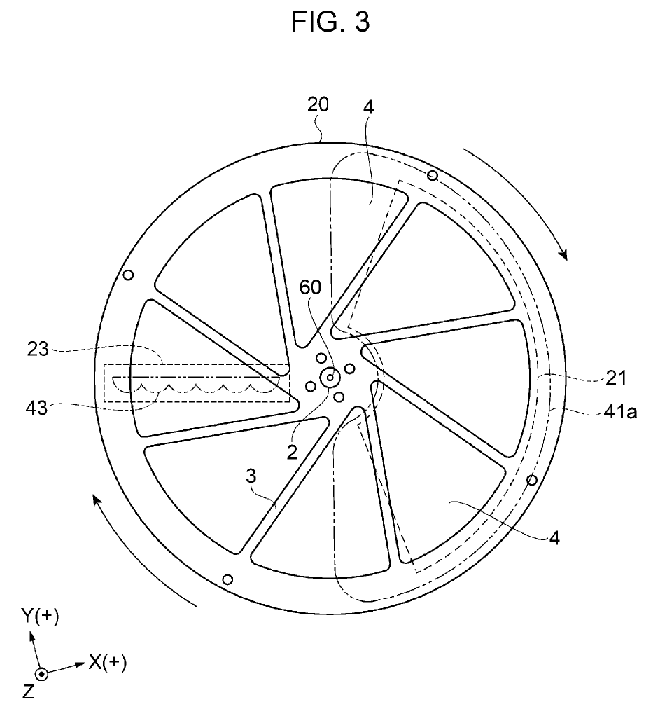

FIG. 1 is a perspective view of a separation device according to a first embodiment. FIG. 2 is an exploded perspective view of a main portion of the separation device. FIG. 3 is an explanatory view of a function of the separation device. Hereinafter, embodiments of the present disclosure will be described with reference to the drawings.

A separation device 100 of the present embodiment illustrated in FIG. 1 is a dry type separation device that screens a material that can be used in a downstream process and foreign matter from a defibrated material of a raw material supplied from an upstream process according to a difference in size. In each of the drawings, an X-axis, a Y-axis, and a Z-axis are illustrated as three axes orthogonal to each other. In the present embodiment, an extending direction of one side of the separation device 100 having a rectangular shape in plan view is defined as an X plus direction, an extending direction of a side intersecting with the one side is defined as a Y plus direction, and a thickness direction of the separation device 100 is defined as a Z plus direction. In a preferred example, the Z plus direction is vertically upward, and the Z plus direction is also referred to as upward, and a Z minus direction is also referred to as downward. The Z plus direction is not limited to vertically upward, and an installation mode of the separation device 100 can be set as appropriate.

As illustrated in FIG. 2, the separation device 100 has a configuration in which a sieve 20, a cover member 33, and an upper frame 30 are stacked on a support frame 40.

The sieve 20 is a circular plate-shaped sieve including a mesh 4 and is provided so as to be rotatable around a rotation shaft 2. The sieve 20 is a sieve in which the mesh 4 is stretched over the entire surface of a circular plate frame including an annular portion 1 that is an outer ring of an outer periphery and a plurality of spokes 3 that connects a central portion provided with the rotation shaft 2 and the annular portion 1. The rotation shaft 2 is rotatably supported by a bearing 28 of the support frame 40 and a bearing 29 of the upper frame 30. A line segment passing through the bearing 28 and the bearing 29 along the rotation shaft 2 is referred to as a center line 60. In other words, the sieve 20 rotates around the center line 60. A surface of the sieve 20 on a Z plus side is also referred to as a front surface, and a surface on a Z minus side is also referred to as a back surface.

First, a function of the separation device 100 will be described with reference to FIG. 3. FIG. 3 is a view of the sieve 20 when viewed from the Z plus side. Outlines of a first chamber 21 and a third chamber 23 located further on the Z plus side than is the sieve 20 are indicated by broken lines, and outlines of an opening portion 41a and an opening portion 43 located further on the Z minus side than is the sieve 20 are indicated by two dot broken lines.

The first chamber 21 is a substantially semicircular section in plan view, and a first pipe 11 is connected to an upper portion of the first chamber 21. The opening portion 41a (FIG. 2) is provided below the first pipe 11 with the sieve 20 interposed therebetween. A second pipe 12 is connected to a lower portion of the opening portion 41a.

The third chamber 23 is a section having a rectangular shape in plan view and is provided at a position facing the first chamber 21 via the center line 60. A third pipe 13 is provided above the third chamber 23. The opening portion 43 (FIG. 2) of a fourth pipe 14 is provided below the third pipe 13 with the sieve 20 interposed therebetween.

Although not illustrated in FIG. 3, a second chamber 22 is a fan-shaped section with the center line 60 as a center in plan view and is provided between the first chamber 21 and the third chamber 23 further on the Z plus side than is the sieve 20. A fourth chamber 24 is a fan-shaped section with the center line 60 as a center in plan view and is provided between the third chamber 23 and the first chamber 21 further on the Z plus side than is the sieve 20.

The first chamber 21 to the fourth chamber 24 are arranged in the order of the first chamber 21, the second chamber 22, the third chamber 23, and the fourth chamber 24 clockwise around the center line 60. That is, the front surface of the sieve 20 circulates in the order of the first chamber 21, the second chamber 22, the third chamber 23, the fourth chamber 24, and the first chamber 21 by rotating. A rotation direction of the sieve 20 may be counterclockwise, and in this case, the first chamber 21 to the fourth chamber 24 are arranged counterclockwise.

In the separation device 100, air containing a raw material made of a defibrated material is blown from the first pipe 11 to the sieve 20 through the first chamber 21. At this time, a negative pressure is applied to the first chamber 21 from the second pipe 12 through the sieve 20. Therefore, in the raw material blown onto the mesh 4, foreign matter that has passed through openings of the mesh 4 pass through the opening portion 41a and is sucked into the second pipe 12. The foreign matter sucked into the second pipe 12 is collected or discarded.

The defibrated material that has not passed through the openings of the mesh 4 accumulates as a cotton-like material on the front surface of the sieve 20. The material moves while accumulating in a strip shape on the front surface of the sieve 20 with the rotation of the sieve 20, enters the second chamber 22, and then enters the third chamber 23. That is, the mesh 4 of FIG. 3 is a mesh with a front surface on which the defibrated material accumulates.

In the second chamber 22, the material is humidified by humidified air from a humidifying pipe 15 (FIG. 1).

When the material enters the third chamber 23 by the rotation of the sieve 20, the material is peeled from the mesh 4 by air blown from the fourth pipe 14 through the opening portion 43 and is sucked into the third pipe 13 through the third chamber 23. At this time, the air from the fourth pipe 14 is humidified air. The air containing the material sucked into the third pipe 13 is sent to a downstream process.

In this manner, as illustrated in FIG. 1, the separation device 100 filters a raw material 5 supplied from an upstream process by the sieve 20 and screens a material 7, which is a filtration product, and foreign matter 6 by the difference in size. The material 7 is sent to a downstream process through the third pipe 13. The foreign matter 6 is sent to a downstream process through the second pipe 12 and is collected or discarded.

### Configuration of Separation Device

The description returns to FIG. 1.

As illustrated in FIG. 1, a motor 8, the first pipe 11, the humidifying pipe 15, the third pipe 13, and the like are provided on an upper portion of the upper frame 30.

The motor 8 is a drive motor of the sieve 20 and rotates a pinion gear 2b of the rotation shaft 2 (FIG. 2) of the sieve 20 via a gear train mechanism (not illustrated).

The first pipe 11 is formed integrally with the upper frame 30 above the first chamber 21 (FIG. 3). In practice, the first pipe 11 extends to an upstream device, but illustration thereof is omitted. Other pipes similarly extend to related devices, but illustration thereof is omitted.

The humidifying pipe 15 is connected to a humidification device (not illustrated) and sends humidified air supplied from the humidification device to the second chamber 22 (FIG. 3). The humidification device includes, for example, an ultrasonic humidifier and a blower and supplies humidified air having a larger amount of moisture per unit volume than the air from the first pipe 11.

The humidifying pipe 15 is integrated with a pipe cover 15b, and the pipe cover 15b covers an upper portion of the second chamber 22 (FIG. 3) and constitutes a portion of the second chamber 22. The pipe cover 15b is provided with a communication path 15c extending to the fourth chamber 24 (FIG. 3). The humidified air is also supplied to the fourth chamber 24 (FIG. 3) by the communication path 15c.

The third pipe 13 is provided at a position facing the first pipe 11 via the center line 60. As illustrated in FIG. 2, an outlet of the third chamber 23 of the upper frame 30 has a rectangular shape, and the third pipe 13 is a circular pipe having a diameter surrounding the outlet and is attached to the upper portion of the upper frame 30. In FIG. 2, the humidifying pipe 15, the motor 8, and the like are not illustrated.

As illustrated in FIG. 1, the second pipe 12, the fourth pipe 14, and the like are provided below the support frame 40.

The second pipe 12 is provided below the first pipe 11 with the sieve 20 interposed therebetween.

The fourth pipe 14 is provided below the third pipe 13 with the sieve 20 interposed therebetween. The fourth pipe 14 is connected to a humidification device (not illustrated) and sends humidified air supplied from the humidification device to the third chamber 23 (FIG. 3) through the sieve 20. In a preferred example, the humidification device is the same device as the humidification device to which the humidifying pipe 15 is connected.

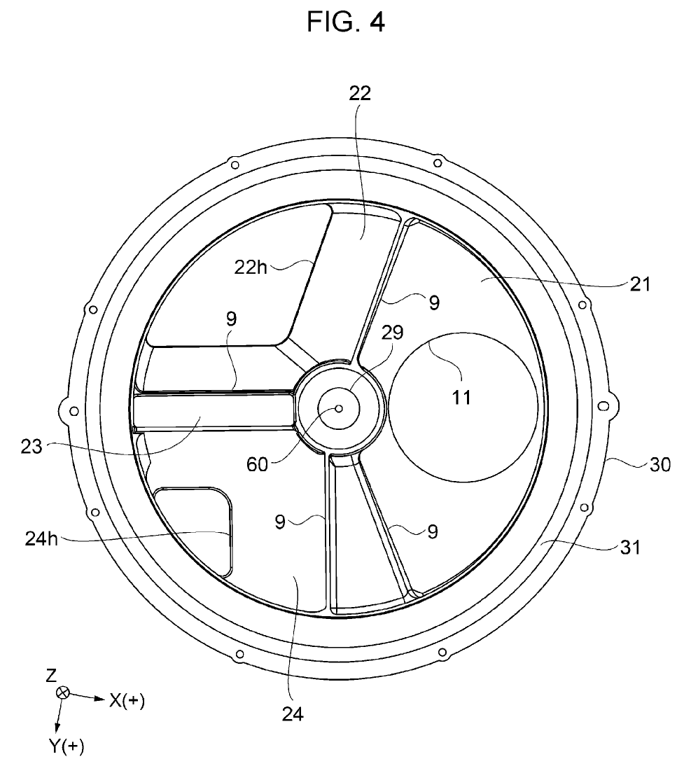

FIG. 4 is a plan view of a back surface of the upper frame.

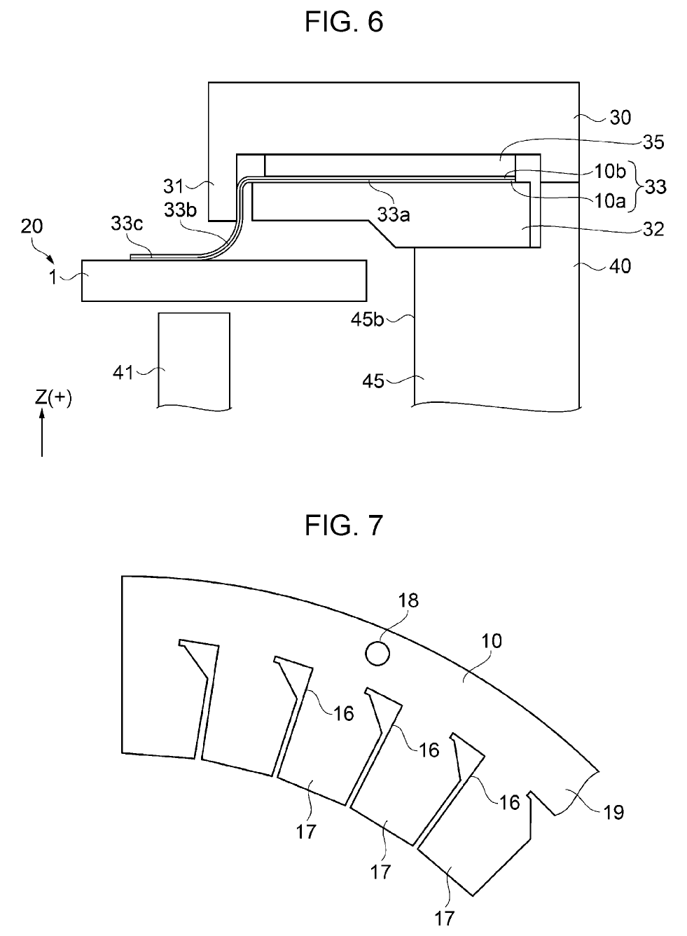

As illustrated in FIG. 4, the upper frame 30 has a circular shape slightly larger than the sieve 20 (FIG. 2) in plan view. An annular projection 31 slightly smaller than an outer shape is provided on a back surface of the upper frame 30. The projection 31 has a diameter slightly smaller than an outer periphery of the sieve 20 and comes into contact with the cover member 33 (FIG. 6) at the time of assembly. The projection 31 will be described in detail later.

As illustrated in FIG. 4, the first chamber 21 to the fourth chamber 24 are formed around the bearing 29 in a circular portion inside the projection 31.

The first chamber 21 is a substantially semicircular section in plan view, and the first pipe 11 is connected to a bottom of the first chamber 21. The third chamber 23 is a section having a rectangular shape in plan view and is provided at a position facing the first chamber 21 via the center line 60.

The second chamber 22 is a fan-shaped section with the center line 60 as a center in plan view and is provided between the first chamber 21 and the third chamber 23. The fourth chamber 24 is a fan-shaped section with the center line 60 as a center in plan view and is provided between the third chamber 23 and the first chamber 21.

The first chamber 21 to the fourth chamber 24 are defined by a plurality of partition walls 9 radially extending from the bearing 29. The first chamber 21 has a mortar shape with the first pipe 11 as a bottom.

A fan-shaped hole 22h is provided at the bottom of the second chamber 22. A fan-shaped hole 24h is provided at the bottom of the fourth chamber 24. The hole 22h and the hole 24h are covered by the pipe cover 15b and the communication path 15c of the humidifying pipe 15.

The description returns to FIG. 2.

As illustrated in FIG. 2, the support frame 40 is provided with a circular housing portion 45 for housing the sieve 20 with the bearing 28 as a center. The sieve 20 rotates in a space in the housing portion 45.

A circular tubular portion 41 slightly smaller than the housing portion 45 is provided inside the housing portion 45. A portion of the tubular portion 41 overlapping with the first chamber 21 (FIG. 3) has a mortar shape with the second pipe 12 as a bottom.

An eaves-shaped top plate 42 is provided at a portion of the tubular portion 41 overlapping with the second chamber 22 (FIG. 3) and the fourth chamber 24. The top plate 42 is located directly below the sieve 20 along the sieve 20 at the time of assembly. The top plate 42 can prevent occurrence of air turbulence which turns up the accumulated material 7.

The linear opening portion 43 is provided in the top plate 42 overlapping with the third chamber 23 (FIG. 3) of the tubular portion 41. The opening portion 43 is formed by connecting semicircular holes in a straight line. The fourth pipe 14 is provided on a back surface side of the opening portion 43 in the top plate 42.

The humidified air supplied from the fourth pipe 14 is blown to the back surface of the sieve 20 as a curtain-like strong airflow from the opening portion 43. A leading end of the material 7 (FIG. 3) accumulating in a strip shape is peeled off by the linear airflow. The peeled material 7 is sucked into the third pipe 13.

As illustrated in FIG. 2, the annular cover member 33 is provided between the sieve 20 and the upper frame 30. The cover member 33 is in contact with a top of the annular portion 1 of the sieve 20, and even when the accumulated material 7 moves to an outer peripheral side due to a centrifugal force or the like at the time of rotation of the sieve 20, the cover member 33 prevents the material 7 from moving further outward. In a preferred example, the annular portion 1 is made of stainless steel. The material is not limited to stainless steel, and may be another metal or resin as long as the material has rigidity.

### Configuration of Cover Member

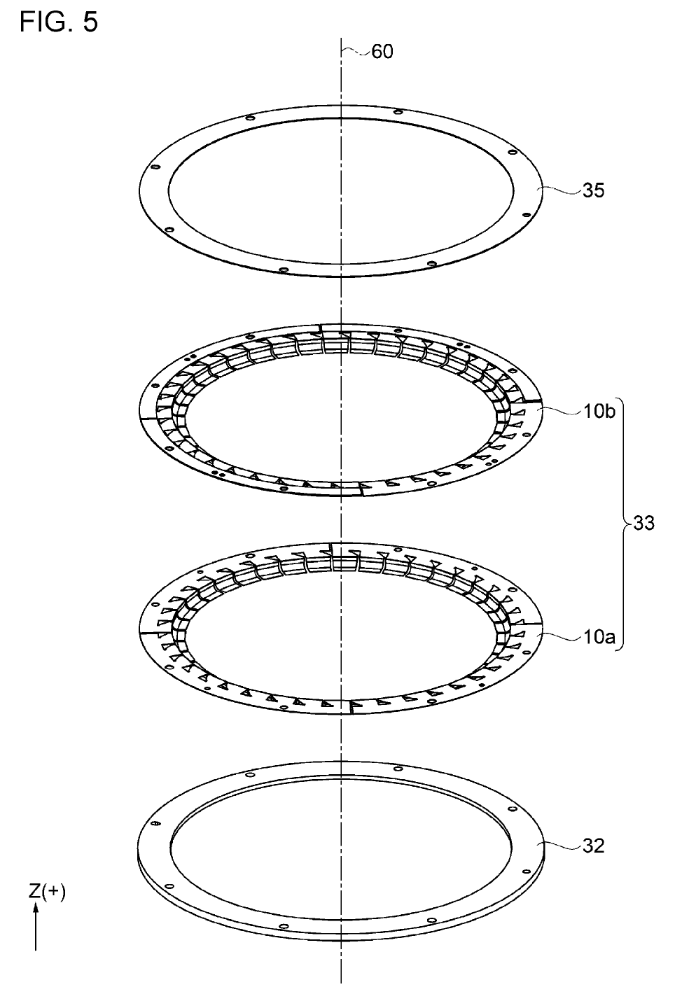

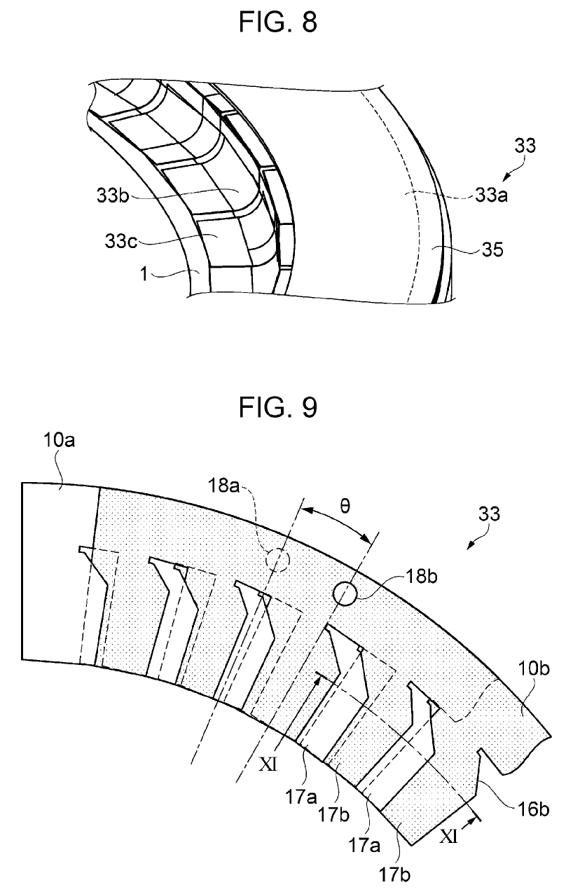

FIG. 5 is an exploded perspective view of the cover member. FIG. 6 is a side sectional view of the cover member at the time of assembly. FIG. 7 is a partial plan view of a sheet. FIG. 8 is an enlarged view of a portion VIII in FIG. 2.

As illustrated in FIG. 5, the cover member 33 is configured by overlapping a ring-shaped first sheet 10a with a ring-shaped second sheet 10b. The first sheet 10a and the second sheet 10b are the same sheets as a sheet 10 illustrated in FIG. 7, but are overlapped with each other by shifting an arrangement angle at the time of overlapping. A peripheral edge of the cover member 33 is held between a support ring 32 and a press ring 35.

As illustrated in FIG. 6, the support ring 32 is set on the housing portion 45 of the support frame 40. The support ring 32 is an annular ring and is provided above the annular portion 1 of the sieve 20. The material of the support ring 32 is not particularly limited, and may be resin, metal, wood, or the like. One end of the support ring 32 is fixed to the support frame 40 side, and the other end is located above the peripheral edge of the annular portion 1.

The press ring 35 is an annular ring having a width slightly smaller than that of the support ring 32 and is set on the upper frame 30 side. The projection 31 of the upper frame 30 is a projecting portion and is provided on an inner peripheral side of the support ring 32.

At the time of assembly, when the upper frame 30 is set from above the flat plate-shaped cover member 33 mounted on the support ring 32, as illustrated in FIG. 6, the projection 31 presses down and bends the cover member 33 to bring an end portion side of the cover member 33 into contact with the annular portion 1. At this time, a flat outer peripheral portion of the cover member 33 along the support ring 32 is defined as an outer portion 33a, an inner peripheral portion along the annular portion 1 is defined as an inner portion 33c, and a bent portion between the outer portion 33a and the inner portion 33c is defined as a bent portion 33b. The cover member 33 serves to cover a gap between the annular portion 1 of the sieve 20 and a wall portion 45b of the housing portion 45 of the support frame 40. Specifically, a gap between the annular portion 1 and the projection 31 of the upper frame 30 is covered. As described above, when the gap between an outer edge of the annular portion 1 and the wall portion 45b of the housing portion 45 is clogged with the material 7, a rotation failure of the sieve 20 may occur, but the failure can be prevented by the cover member 33.

In other words, the upper frame 30 has the projection 31 as a projecting portion projecting toward the front surface side of the sieve 20, and the cover member 33 is pressed toward the sieve 20 by the projection 31, whereby the bent portion 33b causes the inner portion 33c to conform to the annular portion 1. The cover member 33 covers the gap between the annular portion 1 and the upper frame 30 on the front surface side where the raw material is charged into the sieve 20.

As a result, as illustrated in FIG. 8, even when the annular portion 1 of the sieve 20 rotates, the inner portion 33c of the cover member 33 is urged against the annular portion 1 by the resiliency of the bent portion 33b, so that the inner portion 33c of the cover member 33 is kept in contact with the annular portion 1. Maintaining the contact state is also referred to as following. As will be described in detail later, the inner portion 33c has a configuration in which a plurality of blades 17 (FIG. 9) overlaps with each other and thus has a configuration in which following is more easily performed.

In other words, the separation device 100 includes the rotating sieve 20 including the mesh 4, the wall portion 45b of the housing portion 45 of the support frame 40 that defines a space in which the sieve 20 rotates, the cover member 33 that covers the gap between the annular portion 1 on the outer periphery of the sieve 20 and the wall portion 45b, and the upper frame 30 outside the space in which the sieve 20 rotates. The cover member 33 has an outer portion 33a along the upper frame 30, the inner portion 33c along the annular portion 1, and the bent portion 33b between the outer portion 33a and the inner portion 33c, and the bent portion 33b causes the inner portion 33c to follow a change in a relative position between the sieve 20 and the upper frame 30.

### Overlapped Mode of Cover Member

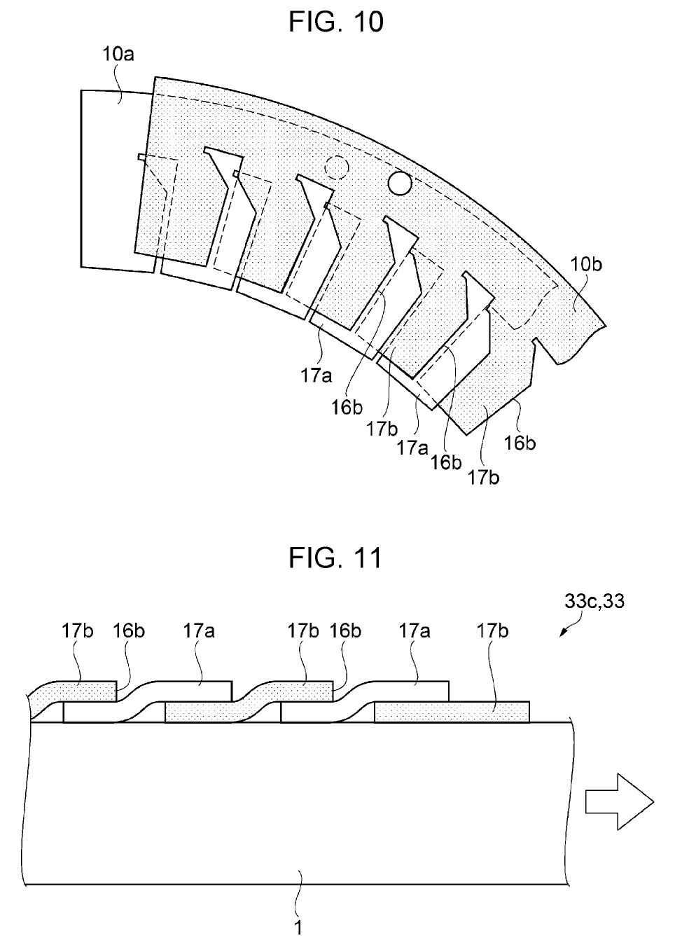

FIG. 9 is a partial plan view of the cover member and corresponds to FIG. 7. FIG. 10 is an explanatory view of an overlapped state and corresponds to FIG. 9. FIG. 10 illustrates a state in which centers of the first sheet 10a and the second sheet 10b are shifted from each other. FIG. 11 is a sectional view taken along line XI-XI of FIG. 9.

First, a configuration of the sheet 10 will be described with reference to FIG. 7.

As illustrated in FIG. 7, the sheet 10 before assembly is a flat film having a plurality of slits 16 on an inner peripheral side. In a preferred example, a polyimide film is used as the sheet 10. However, the present disclosure is not limited thereto, and any sheet member having similar physical properties may be used. The slits 16 extend radially from the center line 60 (FIG. 5) to an annular outer edge portion 19 from the inner peripheral side toward an outer peripheral side. In plan view, each slit 16 has an L shape, and an end portion of the slit 16 is a triangular hole.

The slits 16 are provided at an equal angular pitch at a predetermined angle with the center line 60 as a center. The plurality of blades 17 divided by adjacent slits 16 is provided on the inner peripheral side of the sheet 10. Each blade 17 is a substantially trapezoidal blade having an inner peripheral side as an upper base. By forming the end portion of each slit 16 as a triangular hole, flexibility of the blade 17 is increased, and the blades 17 can be easily overlapped with each other.

A reference hole 18 is provided in the outer edge portion 19 of the sheet 10. The reference hole 18 is a hole for explaining a position at which the sheets are overlapped with each other and does not have to be provided in an actual sheet.

As illustrated in FIG. 9, the cover member 33 is formed by overlapping two sheets of the first sheet 10a made of the sheet 10 and the second sheet 10b made of the sheet 10. In each of the drawings, the second sheet 10b on an upper side is hatched so that the two sheets are easily distinguished from each other.

The second sheet 10b is overlapped on the first sheet 10a such that the arrangement angle at the time of overlapping is shifted by an angle θ. Specifically, as illustrated in FIG. 9, a reference hole 18b of the second sheet 10b is located at a position shifted from a reference hole 18a of the first sheet 10a by the angle θ with the center line 60 as a center.

As illustrated in FIG. 9, a second blade 17b of the second sheet 10b and a first blade 17a of the first sheet 10a are overlapped with each other at a position of the slit 16 such that the second blade 17b and the first blade 17a are alternately exposed. Specifically, as illustrated in FIG. 10, the first blade 17a is passed through a slit 16b of the second sheet 10b so as to be overlapped on the second blade 17b. The overlapping is performed for all the blades.

As a result, as illustrated in FIG. 11, the second blade 17b and the first blade 17a are alternately overlapped on the annular portion 1 in a forward direction from a downstream side in the rotation direction of the annular portion 1. In FIG. 11, the rotation direction of the annular portion 1 is indicated by a white arrow, and a leading end direction of the arrow is downstream of the rotation direction. When the sieve 20 rotates, the defibrated material also moves in the rotation direction, but it is possible to suppress slipping of the defibrated material under the first blade 17a and the second blade 17b. As a result, it is possible to suppress moving of the defibrated material toward the gap between the annular portion 1 and the upper frame 30. In addition, the friction between the annular portion 1 and the inner portion 33c can be reduced. Further, in a preferred example, the annular portion 1 is made of stainless steel, and the cover member 33 is made of polyimide. Since a combination of stainless steel and polyimide has a small friction coefficient, the friction between the annular portion 1 and the inner portion 33c can be further reduced. In other words, the cover member 33 includes the first sheet 10a having the outer portion 33a fixed to the upper frame 30 and having the slits 16 from the inner portion 33c to the bent portion 33b, and the second sheet 10b having the same shape as the first sheet 10a, the first sheet 10a is provided with the plurality of first blades 17a divided by the slits 16, the second sheet 10b is provided with the plurality of second blades 17b divided by the slits 16, and in the first sheet 10a and the second sheet 10b, the first blades 17a and the second blades 17b are alternately overlapped at positions of the slits 16. When the second sheet 10b is overlapped on the first sheet 10a, the second blades 17b and the first blades 17a are alternately overlapped on the annular portion 1 in the forward direction from the downstream side in the rotation direction of the annular portion 1.

### Method for Producing Filtration Product

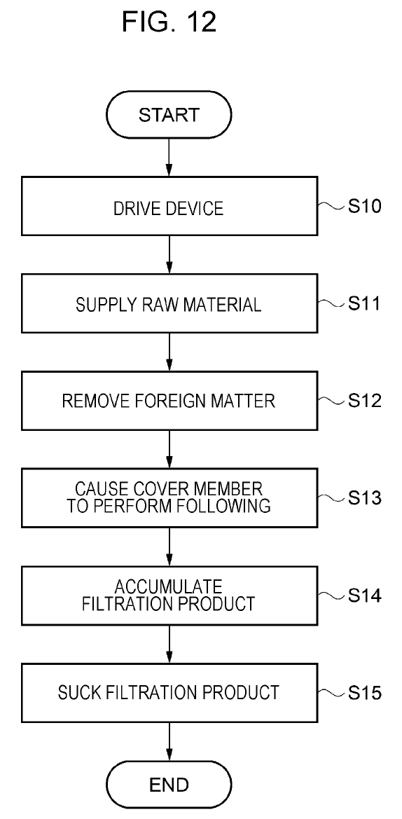

FIG. 12 is a flowchart illustrating a flow of a method for producing a filtration product by the separation device.

Here, a method for producing the material 7 as the filtration product by the separation device 100 will be described mainly with reference to FIG. 12 and appropriately with reference to other drawings.

In step S10, the separation device 100 is operated. In particular, a control device (not illustrated) operates the separation device 100 and related upstream and downstream devices.

In step S11, a raw material is supplied to the separation device 100. Specifically, as illustrated in FIG. 3, air containing the raw material 5 made of a defibrated material is supplied from the first pipe 11 to the first chamber 21. At this time, the sieve 20 rotates at a constant speed, and a negative pressure is applied to the first chamber 21 from the second pipe 12 through the sieve 20.

In step S12, foreign matter is removed. Specifically, as illustrated in FIG. 3, in the raw material 5 blown onto the mesh 4 of the sieve 20, the foreign matter 6 that has passed through the openings of the mesh 4 is sucked through the second pipe 12.

In step S13, the cover member 33 performs following with the rotation of the sieve 20. Specifically, even when the annular portion 1 of the sieve 20 rotates, as illustrated in FIG. 6, the state in which the inner portion 33c is in contact with the annular portion 1 is maintained, and the material 7 remains in the sieve 20.

In step S14, the material 7 accumulates as the filtration product on the sieve 20. In detail, as illustrated in FIG. 3, the defibrated material that has not passed through the openings of the mesh 4 accumulates on the front surface of the sieve 20 as the cotton-like material 7. In a preferred example, the material 7 is mainly composed of fibers longer than the openings, but may contain particles larger than the openings.

In step S15, the material 7 is sucked and sent to a downstream process. Specifically, as illustrated in FIG. 3, when the material 7 enters the third chamber 23 by the rotation of the sieve 20, the material 7 is sucked into the third pipe 13. At the same time, humidified air is blown from the fourth pipe 14. As a result, the material 7 is sucked into the third pipe 13 in a sufficiently humidified state, and thus adhesion of the material 7 to the inside of the pipe due to static electricity is suppressed.

In other words, in the method for producing the material 7 as the filtration product by the separation device 100, the raw material 5 in which the filtration product and the foreign matter are mixed is supplied to the front surface side of the sieve 20, the bent portion 33b is used to cause the inner portion 33c to follow a change in the relative position between the sieve 20 and the upper frame 30 caused by the rotation, the foreign matter 6 is collected from one of the front surface side and the back surface side of the sieve 20 after the rotation, and the material 7 as the filtration product is collected from the other one of the front surface side and the back surface side of the sieve 20 after the rotation.

The order of the above-described steps is described so as to have an order for the sake of description, but in practice, step S11 to step S15 are performed simultaneously in parallel.

As described above, according to the separation device 100 and the method for producing a filtration product of the present embodiment, the following effects can be obtained.

The separation device 100 includes the rotating sieve 20 including the mesh 4, the wall portion 45b of the housing portion 45 of the support frame 40 that defines a space in which the sieve 20 rotates, the cover member 33 that covers the gap between the annular portion 1 on the outer periphery of the sieve 20 and the wall portion 45b, and the upper frame 30 outside the space in which the sieve 20 rotates. The cover member 33 has the outer portion 33a along the upper frame 30, the inner portion 33c along the annular portion 1, and the bent portion 33b between the outer portion 33a and the inner portion 33c, and the bent portion 33b causes the inner portion 33c to follow a change in the relative position between the sieve 20 and the upper frame 30.

According to this configuration, even when the material 7 moves to the outer peripheral side of the sieve 20 due to a centrifugal force or the like, since the inner portion 33c of the cover member 33 follows the annular portion 1, the material 7 can be prevented from moving further outward. Therefore, the material 7 can be retained in the sieve 20 by the cover member 33 differently from the separation device in the related art in which there is a possibility that the gap between the outer peripheral edge of the mesh disk and the support portion is clogged with the filtration product.

Therefore, it is possible to provide the separation device 100 that is less likely to be clogged with the filtration product and operates stably.

The cover member 33 includes the first sheet 10a having the outer portion 33a fixed to the upper frame 30 and having the slits 16 from the inner portion 33c to the bent portion 33b, and the second sheet 10b having the same shape as the first sheet 10a, the first sheet 10a is provided with the plurality of first blades 17a divided by the slits 16, the second sheet 10b is provided with the plurality of second blades 17b divided by the slits 16, and in the first sheet 10a and the second sheet 10b, the first blades 17a and the second blades 17b are alternately overlapped at positions of the slits 16.

According to this configuration, since the inner portion 33c has a configuration in which the second blades 17b and the first blades 17a are alternately overlapped with each other in the forward direction, the followability to the annular portion 1 is excellent.

When the second sheet 10b is overlapped on the first sheet 10a, the second blades 17b and the first blades 17a are alternately overlapped on the annular portion 1 in the forward direction from the downstream side in the rotation direction of the annular portion 1. According to this configuration, it is possible to suppress a possibility that the filtration product slips under the first blades 17a and the second blades 17b and the gap between the outer peripheral edge of the mesh disk and the support portion is clogged with the filtration product when the sieve 20 rotates.

Each slit 16 has an L shape. The end portion of the slit 16 is a triangular hole. According to this configuration, the plurality of blades 17 can be provided by the adjacent slits 16. By forming the end portion of each slit 16 as a triangular hole, it is possible to increase the flexibility of the blades 17 and to easily overlap the blades 17 with each other.

The cover member 33 covers the gap between the annular portion 1 and the upper frame 30 on the front surface side where the raw material is charged into the sieve 20.

According to this configuration, the material 7 can be prevented from moving to the outside of the cover member 33.

The upper frame 30 has the projection 31 as a projecting portion projecting toward the front surface side of the sieve 20, and the cover member 33 is pressed toward the sieve 20 by the projection 31, whereby the bent portion 33b causes the inner portion 33c to conform to the annular portion 1.

According to this configuration, the inner portion 33c of the cover member 33 can satisfactorily follow the rotating annular portion 1.

In the method for producing the material 7 as a filtration product by the separation device 100, the raw material 5 in which the filtration product and the foreign matter are mixed is supplied to the front surface side of the sieve 20, the bent portion 33b is used to cause the inner portion 33c to follow a change in the relative position between the sieve 20 and the upper frame 30 caused by the rotation, the foreign matter 6 is collected from one of the front surface side and the back surface side of the sieve 20 after the rotation, and the material 7 as the filtration product is collected from the other one of the front surface side and the back surface side of the sieve 20 after the rotation.

According to this configuration, it is possible to provide a method for producing a filtration product in which clogging of the filtration product is unlikely to occurs and the operation is stable.

### Second Embodiment

### Application to Sheet Production Apparatus

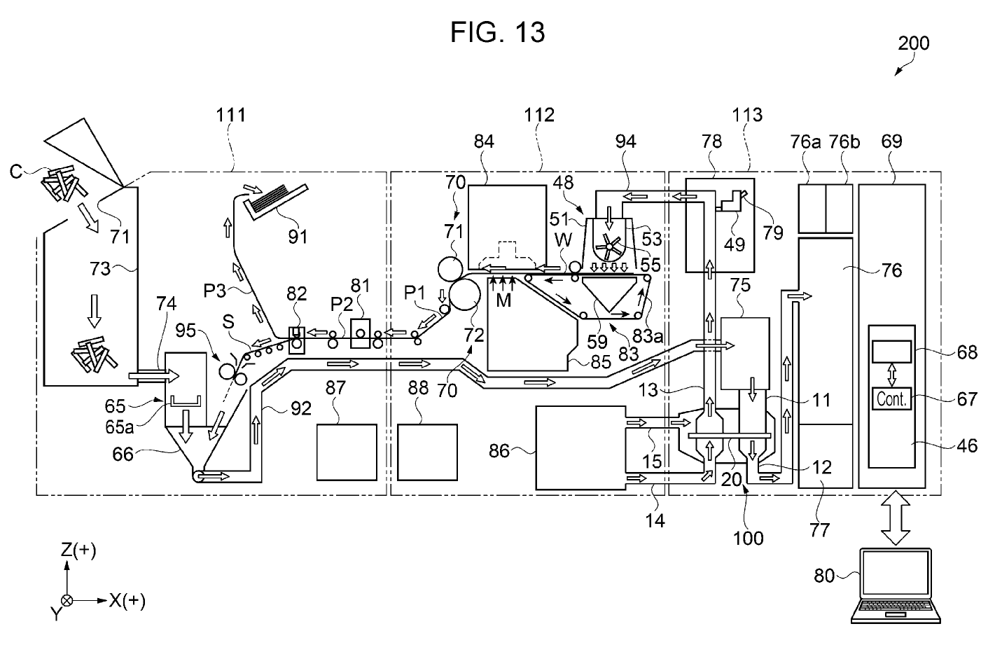

FIG. 13 is a schematic configuration diagram of a sheet production apparatus according to a second embodiment.

The separation device 100 described above can be suitably applied to a sheet production apparatus 200.

The sheet production apparatus 200 is a sheet production apparatus for producing a sheet from paper pieces C by a dry process. In a preferred example, the paper pieces C are shredded waste paper and contain fibers such as cellulose. The paper pieces C may be any material containing fibers, and may be, for example, paper, pulp, a pulp sheet, cloth including non-woven fabric, or woven fabric. The paper pieces C are not limited to waste paper, and may be unused paper. The process of the sheet production apparatus 200 is not limited to a dry process, and may be a wet process.

As illustrated in FIG. 13, the sheet production apparatus 200 includes a first unit group 111, a second unit group 112, and a third unit group 113. The first unit group 111, the second unit group 112, and the third unit group 113 are supported by a frame (not illustrated).

In FIG. 13, directions in which the paper pieces C, a sheet P3, a slit piece S, unnecessary scraps, and the like move are indicated by white arrows. In the sheet production apparatus 200, the side in the transport direction of the paper pieces C, a web W, the sheet P3, and the like may also be referred to as downstream, and the opposite side in the transport direction may also be referred to as upstream. In the following description, a collection of a plurality of the paper pieces C is also simply referred to as the paper piece C.

The sheet production apparatus 200 manufactures the sheet P3 from the paper piece C. In the sheet production apparatus 200, the first unit group 111, the second unit group 112, and the third unit group 113 are arranged from an X minus direction toward the X plus direction. The separation device 100 described above is housed in the third unit group 113.

The paper piece C is stored in a storage unit 73 of the first unit group 111 and is supplied from the storage unit 73 to a merging unit 66 through a discharge portion 74 and then transported to the third unit group 113 through a pipe 92. Then, the paper piece C is subjected to defibration and the like in the third unit group 113 to become fibers and then to become a mixture containing a binder or the like. The mixture is transported to the second unit group 112 through a pipe 94. The mixture is formed into the web W in the second unit group 112 and then formed into a sheet P1 having a strip shape. The sheet P1 having a strip shape is cut into the sheet P3 in the first unit group 111.

The first unit group 111 includes the storage unit 73, a measuring unit 65, the merging unit 66, and the pipe 92. In the first unit group 111, these components are arranged in this order from upstream toward downstream. The first unit group 111 also includes a first cutting unit 81, a second cutting unit 82, a tray 91, and a shredding unit 95. The first cutting unit 81 and the second cutting unit 82 cut the sheet P1 having a strip shape into the sheet P3 having a predetermined shape. Furthermore, the first unit group 111 includes a water supply unit 87. The water supply unit 87 is a water storage tank. The water supply unit 87 supplies water for humidification to each of a first humidification unit 85 and a second humidification unit 86, which will be described later, through a water supply pipe (not illustrated).

The storage unit 73 stores the paper piece C, which is a raw material of the sheet P3, and supplies the paper piece C downstream through the discharge portion 74. The paper piece C contains fibers such as cellulose and is, for example, shredded waste paper. The inside of the storage unit 73 is supplied with humidified air by the second humidification unit 86 included in the second unit group 112.

The paper piece C is temporarily stored in the storage unit 73 and then transported to the measuring unit 65 through the discharge portion 74. The sheet production apparatus 200 may include a shredder for shredding the paper piece C and the like on the upstream side of the storage unit 73.

The measuring unit 65 includes a sensor unit 65a and a supply mechanism (not illustrated). The sensor unit 65a measures a mass of the paper piece C. The supply mechanism supplies the paper piece C weighed by the sensor unit 65a to the merging unit 66 located downstream. That is, the measuring unit 65 weighs the paper piece C by the sensor unit 65a for each predetermined mass and supplies the paper piece C to the merging unit 66 located downstream by the supply mechanism.

Either a digital weighing mechanism or an analog weighing mechanism can be applied to the sensor unit 65a. Specifically, the sensor unit 65a may be a physical sensor, such as a load cell, a spring balance, a balance scale, or the like. In the present embodiment, the sensor unit 65a is a load cell. The predetermined mass of the paper piece C weighed by the sensor unit 65a is, for example, approximately several grams to several tens of grams.

The weighing and supply of the paper piece C by the measuring unit 65 are batch processing. That is, the paper piece C is intermittently supplied from the measuring unit 65 to the merging unit 66. The measuring unit 65 may include a plurality of combinations of the sensor unit 65a and the supply mechanism, and the plurality of sensor units 65a may be operated at different times to improve the weighing and supplying efficiencies. In a preferred example, the sheet production apparatus 200 includes two sensor units 65a and supply mechanisms attached to the respective sensor units 65a. As a result, the paper piece C is transported alternately from the two pairs of the sensor unit 65a and the supply mechanism to the merging unit 66.

In the merging unit 66, shredded pieces of the slit piece S supplied from the shredding unit 95 are added to and mixed with the paper piece C supplied from the measuring unit 65. Details of the slit piece S and the shredding unit 95 will be described later. The paper piece C mixed with the above-described shredded pieces flow from the merging unit 66 into the pipe 92.

The pipe 92 transports the paper piece C from the first unit group 111 to the third unit group 113 through the second unit group 112, using a suction airflow generated by a defibrating unit 75 located downstream.

The third unit group 113 includes the defibrating unit 75, the separation device 100, a mixing unit 78, a waste powder collection unit 76, and a power supply unit 69.

The paper piece C transported through the pipe 92 flows into the defibrating unit 75. The defibrating unit 75 is a dry defibrator and defibrates the paper piece C supplied from the measuring unit 65 into fibers by a dry process. A known defibrating mechanism can be used as the defibrating unit 75.

The defibrating unit 75 may have a configuration, for example, described below. The defibrating unit 75 includes a stator and a rotor. The stator has a substantially cylindrical inner surface. The rotor is installed inside the stator and rotates along the inner surface of the stator. Small pieces of the paper piece C are interposed between the inner surface of the stator and the rotor and is defibrated by a shearing force generated therebetween. As a result, the paper piece C become the raw material 5 (FIG. 3) containing an entangled defibrated material contained in the paper piece. The paper piece C is formed into fibers and transported to the separation device 100.

As illustrated in FIG. 13, air containing the raw material is supplied from the first pipe 11 to the separation device 100. The separation device 100 is the above-described separation device, filters the raw material with the sieve 20, and screens the material which is the filtration product and foreign matter by a difference in size. Specifically, relatively long fibers and relatively short fibers are separated from each other, the long fibers are used as the material, and the short fibers are used as the foreign matter. The foreign matter also includes coloring materials and additives contained in the paper piece C.

The fourth pipe 14 and the humidifying pipe 15 of the separation device 100 are connected to the second humidification unit 86. Thus, humidified air from the humidifying pipe 15 is blown to the material accumulating on the front surface of the sieve 20. Humidified air is blown from the fourth pipe 14 to the back surface side of the sieve 20. The second humidification unit 86 includes an ultrasonic humidifier and a blower and supplies humidified air having a larger amount of moisture per unit volume than the air from the first pipe 11. The second humidification unit 86 is not limited to an ultrasonic type and is sufficient as long as it has an equivalent humidifying function. For example, the second humidification unit 86 may include a heating type or vaporizing type humidifier.

The material that is the filtration product accumulating on the sieve 20 is transported to the mixing unit 78 through the third pipe 13. Specifically, the material is sucked and transported to the mixing unit 78 through the third pipe 13 by an airflow generated by a blower (not illustrated) provided on a leading end side of the third pipe 13.

Then, the air containing the foreign matter flows into the waste powder collection unit 76 through the second pipe 12. The foreign matter is also referred to as waste powder.

The waste powder collection unit 76 is a bag filter and is provided with a blower 76a for generating an exhaust flow and a compressor 76b for generating compressed air for cleaning the filter. A plurality of filters (not illustrated) is provided in the waste powder collection unit 76, and the foreign matter in a gas is removed by the filters. The exhaust gas from which the foreign matter has been removed is discharged from an exhaust port (not illustrated). The foreign matter is collected in a waste powder box 77 provided under the waste powder collection unit 76.

The mixing unit 78 mixes a powder additive, such as a binder, with the fibers in the air to form the mixture. The mixing unit 78 includes a powder supply mechanism 49. The powder supply mechanism 49 includes a built-in hopper. The powder supply mechanism 49 is equipped with a powder supply container 79. Although not illustrated, the mixing unit 78 includes a flow path through which the fibers are transported, a valve, and a fan, in addition to the powder supply mechanism 49.

The hopper sends out powder of the binder supplied from the powder supply container 79 into the flow path. In the sheet production apparatus 200, starch is used as a binder for the fibers. The valve (not illustrated) adjusts the flow rate, that is, the mass of the binder supplied from the hopper into the flow path. As a result, the mixing ratio between the fibers and the binder is adjusted. The mixing unit 78 may include similar structures for supplying a coloring material, an additive, or the like, in addition to the powder supply container 79 and the powder supply mechanism 49 that supply the binder. The fan of the mixing unit 78 mixes the binder and the like in the air to form the mixture while transporting the fibers downstream by a generated airflow. The mixture flows from the mixing unit 78 into the pipe 94.

The power supply unit 69 includes a power supply device (not illustrated) that supplies power to a control board 46 and the sheet production apparatus 200. The power supply unit 69 distributes electric power supplied from the outside to each component of the sheet production apparatus 200.

A control unit 67, a storage unit 68, and the like are mounted on the control board 46. In a preferred example, the control unit 67 and the storage unit 68 also have a function of integrally controlling the entire sheet production apparatus 200.

The control board 46 may be connected to a computer 80. The computer 80 is, for example, a notebook computer and stores a control program of the entire sheet production apparatus 200 including the separation device 100.

The second unit group 112 accumulates and compresses the mixture containing the fibers to form the sheet P1 having a strip shape, which is recycled paper. The second unit group 112 includes an accumulating unit 48, a first transport unit 83, a second transport unit 84, the first humidification unit 85, the second humidification unit 86, a drainage unit 88, and a forming unit 70.

In the second unit group 112, the accumulating unit 48, the first transport unit 83, the second transport unit 84, the first humidification unit 85, and the forming unit 70 are arranged in this order from upstream to downstream. The second humidification unit 86 is disposed below the first humidification unit 85.

The accumulating unit 48 accumulates the mixture containing the separated fibers in air to generate the web W. The accumulating unit 48 includes a drum member 53, a blade member 55 disposed inside the drum member 53, a housing 51 that accommodates the drum member 53, and a suction unit 59. The mixture is taken into the drum member 53 through the pipe 94.

The first transport unit 83 is disposed below the accumulating unit 48. The first transport unit 83 includes a mesh belt 83a and five tension rollers (not illustrated) for stretching the mesh belt 83a. The suction unit 59 faces the drum member 53 with the mesh belt 83a interposed therebetween in a direction along the Z-axis.

The blade member 55 is disposed inside the drum member 53 and is rotationally driven by a motor (not illustrated). The drum member 53 is a semicircular columnar sieve. The drum member 53 has a mesh having a function of a sieve on a side surface facing downward. The drum member 53 allows fibers and particles of the mixture or the like smaller than the mesh openings of the sieve to pass therethrough from the inside to the outside.

The mixture is discharged to the outside of the drum member 53 while being stirred by the rotating blade member 55 in the drum member 53. The inside of the drum member 53 is supplied with humidified air by the second humidification unit 86.

The suction unit 59 is disposed below the drum member 53. The suction unit 59 sucks the air inside the housing 51 through a plurality of holes of the mesh belt 83a. The plurality of holes of the mesh belt 83a allows air to pass therethrough but does not allow the fibers, the binder, and the like contained in the mixture to pass therethrough easily. As a result, the mixture that has been discharged to the outside of the drum member 53 is sucked downward together with the air. The suction unit 59 is a known suction device such as a blower.

The mixture is dispersed in the air inside the housing 51 and accumulates on an upper surface of the mesh belt 83a by gravity and suction by the suction unit 59 so as to form the web W.

The mesh belt 83a is an endless belt and is stretched by the five tension rollers. The mesh belt 83a is rotated counterclockwise in FIG. 13 by the rotation of the tension rollers. As a result, the mixture continuously accumulates on the mesh belt 83a to form the web W. The web W contains a relatively large amount of air and is soft and swollen. The first transport unit 83 transports the formed web W downstream by the rotation of the mesh belt 83a.

The second transport unit 84 transports the web W downstream of the first transport unit 83, instead of the first transport unit 83. The second transport unit 84 peels the web W from the upper surface of the mesh belt 83a and then transports the web W to the forming unit 70. The second transport unit 84 is disposed above a transport path of the web W and slightly upstream of a starting point of the mesh belt 83a on a return side. An X plus side of the second transport unit 84 partially overlaps with an X minus side of the mesh belt 83a in a vertical direction. The second transport unit 84 includes a transport belt, a plurality of rollers, and a suction mechanism (not illustrated). The transport belt is provided with a plurality of holes that allows air to pass therethrough. The transport belt is stretched by the plurality of rollers and is rotated by rotation of the rollers.

The second transport unit 84 causes an upper surface of the web W to be sucked onto a lower surface of the transport belt by a negative pressure generated by the suction mechanism. When the transport belt rotates in this state, the web W is sucked onto the transport belt and transported downstream.

The first humidification unit 85 is a humidification device similar to the second humidification unit 86 and humidifies the web W containing the fibers accumulating in the accumulating unit 48 of the second unit group 112. Specifically, the first humidification unit 85 is disposed below the second transport unit 84 and humidifies the web W transported by the second transport unit 84 by supplying mist M from below.

Humidifying the web W with the mist M improves the function of the starch as the binder and increases the strength of the sheet P3. In addition, since the web W is humidified from below, droplets derived from the mist do not fall onto the web W. Moreover, since the web W is humidified from a side opposite to the contact surface between the transport belt and the web W, sticking of the web W to the transport belt is reduced. The second transport unit 84 transports the web W to the forming unit 70.

The forming unit 70 includes processing rollers 71 and 72. The processing rollers 71 and 72 press the web W containing the fibers to form the sheet P1 having a strip shape. The processing rollers 71 and 72 form a pair, and each includes a built-in electric heater that has a function of increasing a temperature of a roller surface.

The processing rollers 71 and 72 are members each having a substantially cylindrical shape. Rotation axes of the processing rollers 71 and 72 extend along the Y-axis. The processing roller 71 is disposed substantially above the transport path of the web W, whereas the processing roller 72 is disposed substantially below the transport path. The processing rollers 71 and 72 are disposed with a gap between side surfaces thereof. The size of the gap corresponds to a thickness of the sheet P3 to be manufactured.

The processing rollers 71 and 72 are rotationally driven by a stepping motor (not illustrated). The web W is sent out downstream by being heated and pressed while being interposed between the processing roller 71 and the processing roller 72. That is, the web W continuously passes through the forming unit 70 and is press-formed while being heated. By using the processing rollers 71 and 72 as a pair of forming members, the web W can be efficiently heated and pressed.

When the web W, which is soft and contains a large amount of air, passes through the forming unit 70, the amount of air in the web W decreases, and the fibers therein are bound together by the binder. In this manner, the web W is formed into the sheet P1 having a strip shape. The sheet P1 having a strip shape is transported to the first unit group 111 by a transport roller (not illustrated).

The second humidification unit 86 is disposed below the first humidification unit 85. The second humidification unit 86 supplies humidified air to the storage unit 73, the separation device 100, the drum member 53 of the accumulating unit 48, and the like.

The drainage unit 88 is a drainage tank. The drainage unit 88 collects and stores moisture that has been used by the first humidification unit 85, the second humidification unit 86, and the like. The drainage unit 88 can be removed from the sheet production apparatus 200 as necessary, and the accumulated water can be discarded.

The sheet P1 having a strip shape transported to the first unit group 111 reaches the first cutting unit 81. The first cutting unit 81 cuts the sheet P1 having a strip shape in a direction intersecting with the transport direction, for example, a direction along the Y-axis. The sheet P1 having a strip shape is cut into a cut sheet P2 by the first cutting unit 81. The cut sheet P2 is transported from the first cutting unit 81 to the second cutting unit 82.

The second cutting unit 82 cuts the cut sheet P2 in a direction parallel to the transport direction. Specifically, the second cutting unit 82 cuts both side portions, in a direction along the X-axis, of the cut sheet P2. As a result, the cut sheet P2 is formed into the sheet P3 having a predetermined shape such as an A4 size or an A3 size, for example.

When the cut sheet P2 is cut into the sheet P3 in the second cutting unit 82, the scrap slit piece S is produced. The slit piece S is transported downward to the shredding unit 95, which is a shredder. The shredding unit 95 shreds the slit piece S into shredded pieces and supplies the shredded pieces to the merging unit 66. A mechanism for weighing the shredded pieces of the slit piece S and supplying the shredded pieces to the merging unit 66 may be provided between the shredding unit 95 and the merging unit 66.

The sheet P3 is transported substantially upward and is stacked on the tray 91. As described above, the sheet P3 is manufactured by the sheet production apparatus 200. The sheet P3 can be used as a substitute for, for example, copy paper or the like.

In other words, the sheet production apparatus 200 includes the separation device 100, the defibrating unit 75 that defibrates the raw material, the accumulating unit 48 that accumulates the material to form the web W, and the forming unit 70 that compresses the web W to form the sheet, and the separation device 100 selects the filtration product from the air containing the raw material defibrated by the defibrating unit 75 and supplies the selected filtration product to the accumulating unit 48 as the material.

As described above, according to the sheet production apparatus 200 of the present embodiment, the following effects can be obtained.

The sheet production apparatus 200 includes the separation device 100, the defibrating unit 75 that defibrates the raw material, the accumulating unit 48 that accumulates the material to form the web W, and the forming unit 70 that compresses the web W to form the sheet, and the separation device 100 selects the filtration product from the air containing the raw material defibrated by the defibrating unit 75 and supplies the selected filtration product to the accumulating unit 48 as the material.

According to this configuration, the sheet production apparatus 200 includes the separation device 100 that includes the cover member 33, is unlikely to be clogged with the filtration product, and operates stably.

Therefore, it is possible to provide the sheet production apparatus 200 capable of producing high-quality sheets with a stable operation.

In the above-described embodiment, a case where a substance to be obtained by filtration is a fiber material that does not pass through the openings of the mesh 4 is exemplified, and thus the substance that has not passed through the openings of the mesh 4 is referred to as the filtration product, and the substance that has passed through the openings of the mesh 4 is referred to as the foreign matter. However, when a substance to be obtained by filtration is a substance that passes through the openings of the mesh 4, the substance that has passed through the openings of the mesh 4 may be referred to as the filtration product, and the substance that has not passed through the openings of the mesh 4 may be referred to as the foreign matter. In addition, in a case where it is desired to separately obtain both of the substance that passes through the openings of the mesh 4 and the substance that does not pass through the openings of the mesh 4, one of the substances may be referred to as the filtration product and the other may be referred to as the foreign matter.

What is claimed is:

1. A separation device comprising:
a rotating sieve including a mesh;
a wall portion that defines a space in which the sieve rotates;
a cover member that covers a gap between an annular portion on an outer periphery of the sieve and the wall portion; and
an upper frame outside the space in which the sieve rotates, wherein
the cover member has an outer portion along the upper frame, an inner portion along the annular portion, and a bent portion between the outer portion and the inner portion, and
the bent portion causes the inner portion to follow a change in a relative position between the sieve and the upper frame.

2. The separation device according to claim 1, wherein
the cover member includes a first sheet having the outer portion fixed to the upper frame and having slits extending from the inner portion to the bent portion, and
a second sheet having a same shape as the first sheet,
the first sheet is provided with a plurality of first blades divided by the slits,
the second sheet is provided with a plurality of second blades divided by the slits, and
in the first sheet and the second sheet, the first blades and the second blades are alternately overlapped with each other at positions of the slits.

3. The separation device according to claim 2, wherein
when the second sheet is overlapped on the first sheet,
the second blades and the first blades are alternately overlapped with each other in a forward direction on the annular portion from a downstream side in a rotation direction of the annular portion.

4. The separation device according to claim 2, wherein
each of the slits has an L shape.

5. The separation device according to claim 1, wherein
the cover member covers a gap between the annular portion and the upper frame on a front surface side where a raw material is charged into the sieve.

6. The separation device according to claim 5, wherein
the upper frame has a projecting portion projecting toward the front surface side of the sieve, and
the bent portion causes the inner portion to conform to the annular portion by the projecting portion pressing the cover member toward the sieve.

7. A sheet production apparatus comprising:
the separation device according to claim 1;
a defibrating unit that defibrates a raw material;
an accumulating unit that accumulates a material to form a web; and
a forming unit that compresses the web to form a sheet, wherein
the separation device selects a filtration product from air containing the filtration product and foreign matter defibrated by the defibrating unit and supplies the selected filtration product to the accumulating unit as the material.

8. A method for producing a filtration product using a separation device including
a rotating sieve having a mesh,
a wall portion that defines a space in which the sieve rotates,
a cover member that covers a gap between an annular portion on an outer periphery of the sieve and the wall portion, and
an upper frame outside the space in which the sieve rotates, in which
the cover member has an outer portion along the upper frame, an inner portion along the annular portion, and a bent portion between the outer portion and the inner portion, the method comprising:
supplying a raw material in which a filtration product and foreign matter are mixed to a front surface side of the sieve;
using the bent portion to cause the inner portion to follow a change in a relative position between the sieve and the upper frame caused by rotation;
after the rotation, collecting the foreign matter from one of the front surface side and a back surface side of the sieve; and
after the rotation, collecting the filtration product from another one of the front surface side and the back surface side of the sieve.
